(19) United States
(12) Patent Application Publication
(10) Pub. No.: US 2009/0131124 A1
(43) Pub. Date: May 21, 2009

(54) WIRELESS EARPIECE DETERMINING PROXIMITY TO USER AND OPERATION BASED THEREON

(75) Inventors: Scott Bibaud, Santa Ana, CA (US); David Murray, Mission Viejo, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/018,834

(22) Filed: Jan. 24, 2008

Related U.S. Application Data
(60) Provisional application No. 60/989,126, filed on Nov. 20, 2007.

(51) Int. Cl. H04M 1/00

(52) U.S. Cl. 455/575.2

(57) ABSTRACT

A wireless earpiece that is configured to fit to an ear of a user includes a sensor for sensing the proximity of the wireless earpiece to the user. The sensor produces a proximity signal indicative of whether the wireless earpiece is engaged with the user. If the proximity signal indicates that the wireless earpiece is engaged with the user, the wireless earpiece automatically initiates communication with a radio device.

### CROSS REFERENCE TO RELATED PATENT APPLICATION

The present U.S. Utility patent application claims priority pursuant to 35 U.S.C. § 119(e) to the following U.S. Provisional Patent Application which is hereby incorporated herein by reference in its entirety and made part of the present U.S. Utility patent application for all purposes:

1. U.S. Provisional Application Ser. No. 60/989,126, entitled “WIRELESS EARPIECE DETERMINING PROXIMITY TO USER AND OPERATION BASED THEREON,” (Attorney Docket No. 6429), filed Nov. 20, 2007, pending.

### STATEMENT REGARDING FEDERALLY SPONSORED RESEARCH OR DEVELOPMENT

Not Applicable INCORPORATION-BY-REFERENCE OF MATERIAL SUBMITTED ON A COMPACT DISC

Not Applicable

### BACKGROUND OF THE INVENTION

1. Technical Field of the Invention

This invention is related generally to wireless communication systems, and more particularly to wireless earpieces for facilitating wireless communication.

2. Description of Related Art

In today's society, multi-tasking has become necessary for individuals to adequately meet all of the demands placed on them. However, in many cases, it is difficult or impossible to carry on more than one task at a time. For example, cellular telephones typically require one hand of the user to hold the telephone close to the user's face and ear, which makes it difficult for the user to engage in other activities, such as cooking, cleaning, driving, typing, carrying objects and other activities which are most easily accomplished using both hands.

To facilitate effective multi-tasking skills, communication providers have begun to offer hands-free communication devices that enable a user to carry on a conversation without using their hands, thereby “freeing” their hands for another task. For example, wireless earpieces that fit to a user's ear allow a user to communicate without requiring the user to hold onto anything. A wireless earpiece can communicate with a cellular telephone, personal digital assistant (PDA), desktop or cordless phone, VoIP device or other communication device using a short range wireless communication standard, such as Bluetooth. The communication device can be carried on the user (e.g., within the user's purse or pocket or mounted within a bracket on the user's belt or pants) or placed within a short distance of the user so as to maintain the short range connection between the wireless earpiece and communication device.

Inbound communication signals for the user that are received by the communication device are forwarded to the wireless earpiece via the short range wireless connection. These inbound communication signals are processed by the wireless earpiece and output to a speaker on the wireless earpiece close to the user's ear. Likewise, outbound communication signals (e.g., speech spoken by the user) are received through a microphone on the wireless earpiece and forwarded to the communication device via the short range wireless connection. The communication device processes the outbound communication signals and transmits them to the appropriate destination.

However, activating a wireless earpiece typically requires the user to manually turn on the wireless earpiece each time the user desires to engage in hands-free communication. This can be undesirable in many situations. For example, if the user is driving when the user decides to activate the wireless earpiece, the user may need to look at the wireless earpiece to locate the power button, thereby causing the user to take his/her eyes off the road, endangering both the user and potentially other drivers and standers-by. In addition, at the completion of a hands-free communication session, the user must remember to turn the power off in order to return to normal operation of the communication device. If the user forgets to turn off the power to the wireless earpiece, the communication device will continue to operate in hands-free mode, which may be undesirable to the user. In addition, the battery will continue to drain at the power-on rate, decreasing the battery life of the wireless earpiece. Therefore, what is needed is a wireless earpiece with an automated power mechanism.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a pictorial representation of a communication system that includes a wireless earpiece and a communication device in accordance with the present invention;

FIG. 2 is a schematic block diagram illustrating an exemplary wireless earpiece in accordance with the present invention;

FIG. 3 is a more detailed schematic block diagram illustrating exemplary portions of the wireless earpiece in accordance with the present invention;

FIG. 4 is a circuit diagram illustrating an exemplary sensor within the wireless earpiece in accordance with the present invention;

FIG. 5 is a schematic diagram illustrating exemplary positioning of the sensor within the wireless earpiece in accordance with the present invention;

FIG. 6 is a schematic block diagram illustrating an exemplary communication device for operating with the wireless earpiece in accordance with the present invention; and

FIG. 7 is a logic diagram of a method for operating the wireless earpiece in accordance with the present invention.

### DETAILED DESCRIPTION OF THE INVENTION

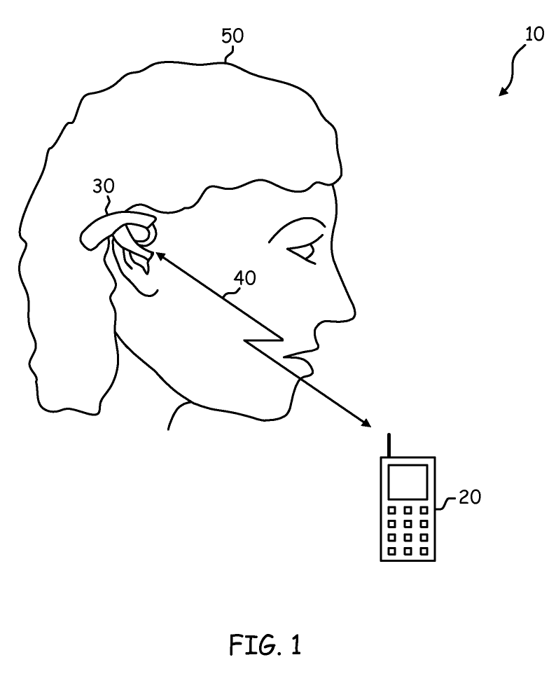

FIG. 1 is a pictorial representation of a communication system 10 that includes a wireless earpiece 30 and a communication device 20 in accordance with the present invention. The communication device 20 may be, for example, a laptop computer, personal digital assistant, personal computer, desktop phone, cordless phone, cellular telephone, VoIP device or other communication device. The wireless earpiece 30 may be, for example, a Behind The Ear (BTE) wireless earpiece, as shown, a Completely In Canal (CIC) wireless earpiece or other type of wireless earpiece that is configured to fit to an ear of a user 50.

The wireless earpiece 30 communicates with the communication device 20 via a wireless link 40. In an exemplary embodiment, a short range wireless communication standard, such as Bluetooth, enables communications between the wireless earpiece 30 and the communication device 20 over the wireless link 40. However, there are a number of well-defined wireless communication standards that could facilitate such wireless communication between the wireless earpiece 30 and the communication device 20, and the present invention is not limited to any particular wireless communication standard or protocol.

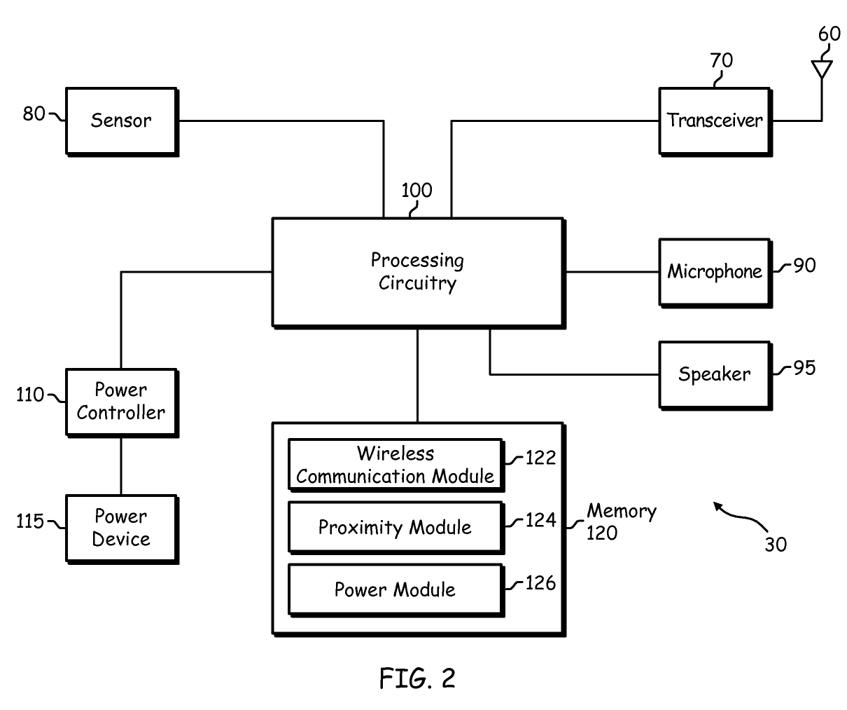

Regardless of the particular standard employed, the wireless earpiece 30 and the communication device 20 each include an antenna and a built-in or externally coupled radio. The radio includes a transceiver (transmitter and receiver) for modulating/demodulating information (data or speech) bits into a format that comports with particular standard used. In addition, in accordance with embodiments of the present invention, and as will described below in connection with FIG. 2, the wireless earpiece 30 is operable to sense the proximity of the wireless earpiece 30 to the user 50 to determine when the wireless earpiece 30 is engaged with the user 50. In further embodiments, the wireless earpiece 30 is operable to control the power provided to the wireless earpiece 30 so that the wireless earpiece 30 is only powered when it is engaged with the user 50.

Although not shown, it should be understood that the communication device 20 is coupled to a network that provides a communication service to the communication device 20. For example, in embodiments in which the communication device 20 is a cellular telephone, the cellular telephone 20 may be coupled to a wireless network via a base station or access point and a network hardware component. The base station or AP is coupled to the network hardware component, which may be a router, switch, bridge, modem, system controller, etc., to provide a wide area network connection for the wireless network. The base station or access point also has an associated antenna or antenna array to communicate with the cellular telephone. Typically, the cellular telephone registers with the base station or access point to receive services from the wireless network. For direct connections (i.e., point-to-point communications), the cellular telephone communicates directly via an allocated channel.

FIG. 2 is a schematic block diagram illustrating an exemplary wireless earpiece 30 in accordance with the present invention. The wireless earpiece 30 includes an antenna 60, transceiver 70, sensor 80, microphone 90, speaker 95, processing circuitry 100, power controller 110, power device 115 and memory 120. Each of the components of the wireless earpiece 30 may be powered by power device 115, or one or more of the components may have a dedicated power device (not shown). For example, in one embodiment, the sensor 80 includes a dedicated power device.

The processing circuitry 100 is communicatively coupled to the memory 120. The memory 120 stores, and the processing circuitry 100 executes, operational instructions corresponding to at least some of the functions illustrated herein. For example, in one embodiment, the memory 120 maintains a wireless communication module 122, a proximity module 124 and a power module 126. The wireless communication module 122 includes instructions executable by the processing circuitry 100 for operating the transceiver 70, antenna 70, microphone 90 and speaker 95 to enable the wireless earpiece 30 to wirelessly communicate with an external communication device using a short range wireless communication standard or protocol. The proximity module 124 includes instructions executable by the processing circuitry 100 for directing the sensor 80 to measure the proximity of the wireless earpiece 30 to a user, and for determining when the wireless earpiece 30 is engaged with a user. The power module 126 includes instructions executable by the processing circuitry 100 for managing the power controller 110 and power device 115.

The processing circuitry 100 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 120 may be a single memory device or a plurality of memory devices. Such a memory device may be a read-only memory, random access memory, volatile memory, non-volatile memory, static memory, dynamic memory, flash memory, and/or any device that stores digital information. Note that when the processing circuitry 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In addition, as one of average skill in the art will appreciate, the wireless earpiece 30 of FIG. 2 may be implemented using one or more integrated circuits. For example, the transceiver 70 may be implemented on a first integrated circuit, while the processing circuitry 100 is implemented on a second integrated circuit, and the remaining components, i.e., the sensor 80, power controller 110, power device 115, microphone 90 and speaker 95 may be implemented on one or more additional integrated circuit. As another example, the transceiver 70 and processing circuitry 100 may be implemented on a single integrated circuit. Further, memory 120 may be implemented on the same integrated circuit as processing circuitry 100 or on a different integrated circuit.

In operation, initially, the power device 115 is in an OFF state, such that all components of the wireless earpiece 30, except for the sensor 80, are operating in a power-off or power-limited state. The sensor 80 measures the proximity of the wireless earpiece 30 to a user of the wireless earpiece 30. For example, in one embodiment, the sensor 80 is a capacitive sensor that detects the presence of a user by measuring the variance in capacitance as the wireless earpiece is placed on the ear of the user. In another embodiment, the sensor 30 is a temperature sensor that measures the temperature on the user side of the earpiece. When the earpiece is placed on the ear of the user, the temperature should change to be at or near body temperature. In yet another embodiment, the sensor 80 is configured to measure the feedback path gain between the speaker 90 and microphone 95 of the wireless earpiece 30. The feedback should be greater when the wireless earpiece 30 is not engaged with the user. In still another embodiment, the sensor 80 is a passive receiver coupled to the speaker 90 that measures an echo from the eardrum of the user. In still a further embodiment, the sensor 80 is configured to sense the proximity of the user by sensing a change in the gain of the antenna 60 of the wireless earpiece 30. It should be understood that the proximity sensor 80 configuration is not limited to examples described herein, and other configurations are possible. For example, proximity sensors can also be designed using ultrasound, infrared or other electromagnetic waves.

The sensor 80 continually measures the proximity of the wireless earpiece 30 to a user and sends a proximity signal indicative of that proximity to the processing circuitry 100. The processing circuitry 100 uses the instructions in the proximity module 124 to process the proximity signal and to determine whether the proximity signal indicates that the wireless earpiece 30 is engaged with a user or that the wireless earpiece 30 is not engaged with a user. If the proximity signal indicates that the wireless earpiece 30 is engaged with a user, the processing circuitry 100 accesses the power module 126 to automatically instruct the power controller 110 to put the power device 115 in an ON state, such that all components of the wireless earpiece 30 are in a power-on state.

Once the wireless earpiece 30 is powered, the processing circuitry 100 attempts to establish a communication connection with and synchronize to an external communication device using the wireless communication module 122, transceiver 70 and antenna 60. For example, in an exemplary embodiment, the wireless earpiece 30 uses the Bluetooth standard to initiate communication with and synchronize to an external communication device. When a connection is established, the wireless communication module 122 continues to operate with the transceiver 70 and antenna 50 to transmit and receive communications (e.g., speech) to and from the external communication device.

For example, outbound speech spoken by the user is received through the microphone 90 of the wireless earpiece 30 and passed to the processing circuitry 100 and/or transceiver 70, which processes the outbound speech in accordance with a particular wireless communication standard (e.g., IEEE 802.11a, IEEE 802.11b, Bluetooth, etc.) to produce an outbound radio frequency (RF) signal containing the formatted speech. The antenna 60 transmits the outbound RF signal to the external communication device for further processing and forwarding to the destination.

The transceiver 70 also receives inbound RF signals via the antenna 60, which were transmitted by the external communication device. The antenna 60 provides the inbound RF signals to the transceiver 70 and/or processing circuitry 100, which decodes, descrambles, demaps, and/or demodulates the inbound signals to recapture inbound speech destined for the user in accordance with the particular wireless communication standard being implemented by the transceiver 70 and/or processing circuitry 100. The transceiver 70 and/or processing circuitry 100 provides the recaptured inbound speech to the speaker 95 for audio output to the user.

The sensor 80 continues to measure the proximity of the wireless earpiece 30 to the user throughout the duration of the communication session between the wireless earpiece 30 and the external communication device. As long as the proximity signal produced by the sensor 80 continues to indicate that the wireless earpiece 30 is engaged with the user, the power device 115 maintains the power ON state. However, when the proximity module 124 determines that the proximity signal indicates that the wireless earpiece 30 is no longer engaged with the user (i.e., the user is pulling the wireless earpiece away from the user's ear), the processing circuitry 100 accesses the power module 126 to automatically instruct the power controller 110 to put the power device 115 back in the OFF state.

By automatically controlling the power state of the wireless earpiece 30, the user is able to activate the wireless earpiece 30 simply by placing the wireless earpiece 30 on the user's ear. Likewise, the user can deactivate the wireless earpiece 30 simply by removing the wireless earpiece 30 from the user's ear.

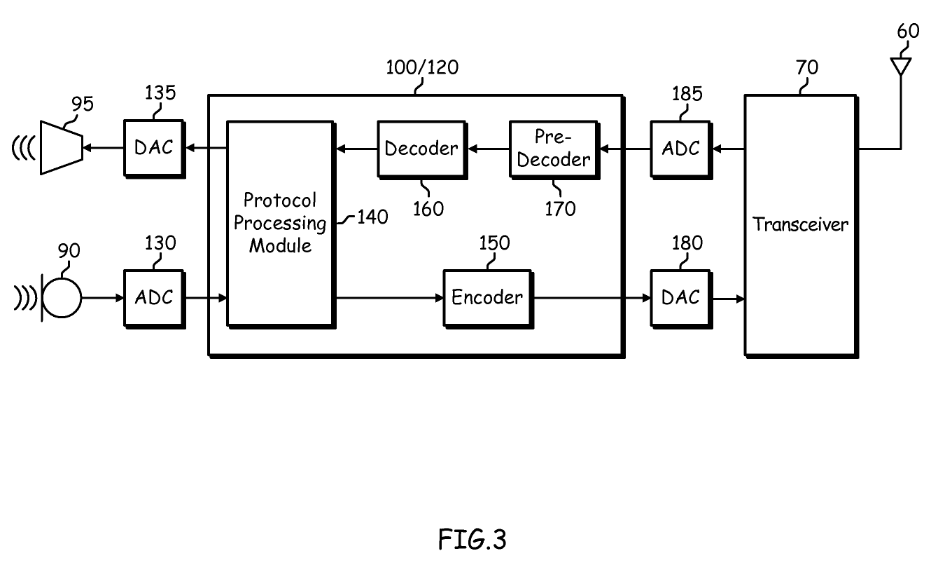

FIG. 3 is a more detailed schematic block diagram illustrating the processing of inbound and outbound communications between the wireless earpiece and the external communication module. In FIG. 3, the digital processing of the communications is performed by the processing circuitry 100, in conjunction with the wireless communication module within memory 120. However, it should be understood that in other embodiments, the transceiver 70 may perform both analog processing and digital processing of the inbound and outbound communications.

The processing circuitry 100 includes a protocol processing module 140, an encoding module 150, a predecoding module 170 and a decoding module 160. The protocol processing module 140 is operably coupled to prepare data for encoding in accordance with a particular short range wireless standardized protocol. In an exemplary embodiment, the protocol processing module 140 is programmed with multiple standardized protocols to enable the wireless earpiece to communicate with any external communication device. In this embodiment, the protocol processing module 140 operates to program filters and other components of the encoding module 150, decoding module 160, pre-decoding module 170 and transceiver 70 in accordance with the particular standardized protocol of the external communication device currently communicating with the wireless earpiece.

In operation, speech received via microphone 90 is input to an analog-to-digital converter 130, which converts the analog speech into digital data and provides the digital data to the protocol processing module 140. Once the particular standardized protocol has been selected for communication with the external communication device, the protocol processing module 140 generates and provides the digital data to be communicated to the external communication device to the encoding module 150 for encoding in accordance with the selected standardized protocol. Thereafter, the encoded data is provided to a digital-to-analog converter 144 which converts the digitally encoded data into an analog signal. The transceiver 70 modulates the analog signal to produce an RF signal at a particular carrier frequency that is transmitted via antenna 60 to the external communication device.

Upon receiving an RF signal from the external communication device, the transceiver 70 converts the received RF signal into a baseband signal. A digitization module 185, which may be a limiting module or an analog-to-digital converter, converts the received baseband signal into a digital signal. The predecoding module 170 converts the digital signal into an encoded signal in accordance with the particular protocol being utilized. The encoded data is provided to the decoding module 160, which recaptures data therefrom in accordance with the particular encoding scheme of the selected protocol. The protocol processing module 140 processes the recovered data, and provides the recovered data to a digital-to-analog converter 135, which outputs the resulting analog speech to the speaker 95.

The transceiver 70 may include filters, a frequency synthesizer or local oscillation module, power amplifiers, low noise amplifiers, up-conversion modules, down-conversion modules and other RF components, as desired. In addition, the antenna 60 may be a single antenna or an antenna array.

The processing module 140 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 140 implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry. Further note that, the memory element stores, and the processing module 140 executes, hard coded and/or operational instructions corresponding to at least some of the steps and/or functions illustrated in FIG. 2 above.

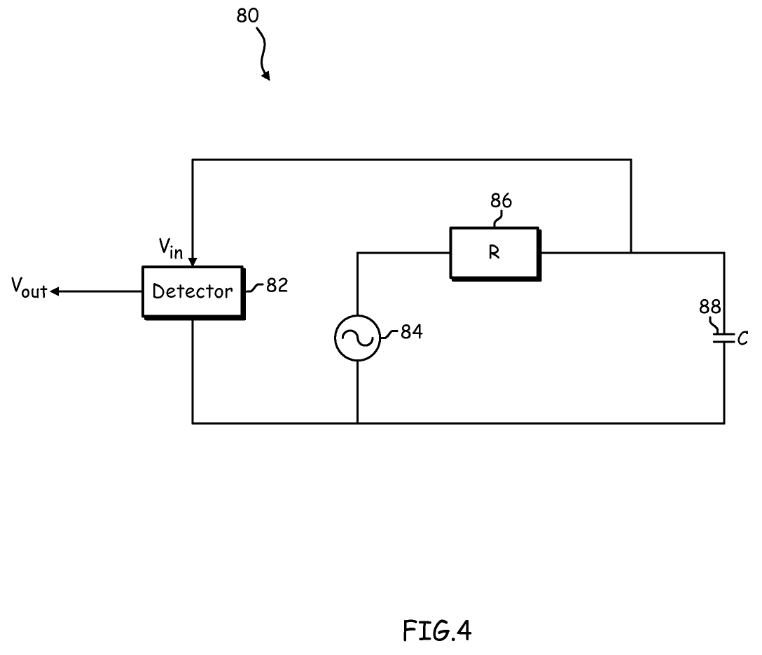

FIG. 4 is a circuit diagram illustrating an exemplary sensor 80 within the wireless earpiece in accordance with the present invention. The sensor 80 shown in FIG. 4 is a capacitive proximity sensor that includes a detector 82, an oscillator 84, resistance (R) 86, and capacitor 88. Oscillator 84 feeds a constant low frequency signal to capacitor 88, causing capacitor 88 to generate an electric field. When a user enters the electric field (i.e., when the wireless earpiece is placed on the user's ear), the sensor 80 detects this proximity by measuring the variance in capacitance as the user comes closer to the capacitor 88. When the user is not proximate to the wireless earpiece, the input signal Vin to detector 82 remains at a constant level, and the output proximity signal Vout indicates that the wireless earpiece is not engaged with a user. However, when the wireless earpiece comes close to a user, the input signal Vin at detector 82 changes, and as such, the output proximity signal Vout changes. When the output proximity signal Vout is above a certain threshold or at a certain level, the output proximity signal indicates that the wireless earpiece is engaged with a user.

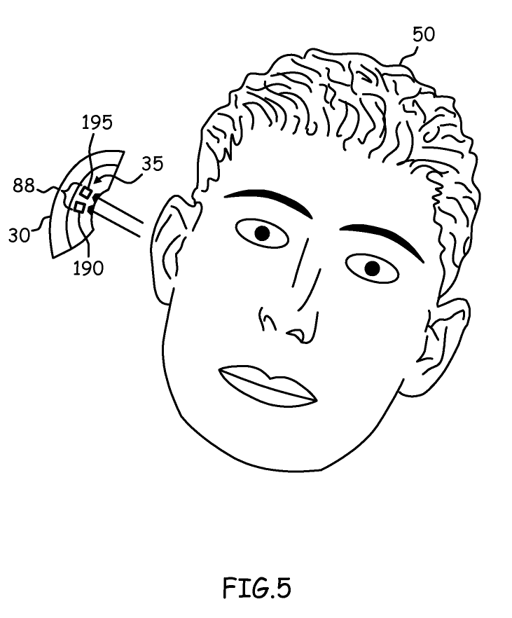

Referring now to FIG. 5, to avoid false detection of user proximity, the sensor is positioned close to an inner side 35 of the wireless earpiece 30 adjacent to the user 50. For example, as shown in FIG. 5, capacitive plates 190 and 195 forming capacitor 88 of sensor are located on the inner side 35 of the wireless earpiece 30. In addition, capacitive plates 190 and 195 are horizontal sensing plates that generate a unidirectional electric field that is more sensitive to stimulus coming from the direction of the user, as indicated by arrows, than from any other direction. Therefore, the sensor is less likely to be activated by a person simply picking up the wireless earpiece.

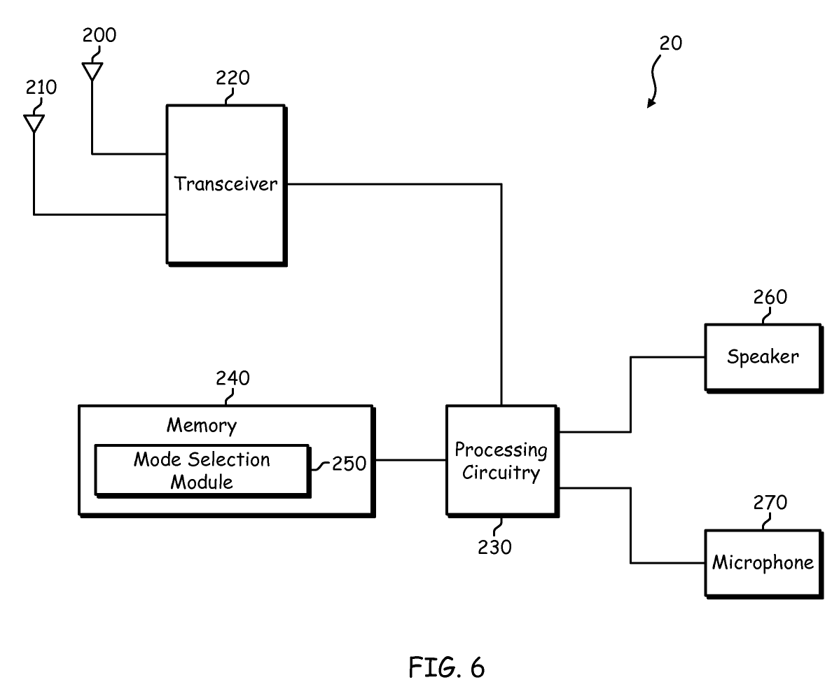

FIG. 6 is a schematic block diagram illustrating an exemplary wireless communication device 20 for operating with the wireless earpiece in accordance with the present invention. The communication device 20 includes antennas 200 and 210, transceiver 220, processing circuitry 230, memory 240, speaker 260 and microphone 270. One of the antennas, e.g., antenna 200, is designed to communicate with the wireless earpiece over a short range connection, while the other antenna, e.g., antenna 210 is designed to communicate with a wireless network. In other embodiments, a single antenna or antenna array can be used to communicate with both the wireless network and a wireless earpiece.

The processing circuitry 230 is communicatively coupled to the memory 240. The memory 240 stores, and the processing circuitry 230 executes, operational instructions corresponding to at least some of the functions illustrated herein. For example, in one embodiment, the memory 240 maintains a mode selection module 250 that includes instructions executable by the processing circuitry 230 for operating the communication device 20 in either a wireless earpiece mode or a handset mode.

In wireless earpiece mode, the speaker 260 and microphone 270 are disabled such that audio signals are not output from the communication device 20 through the speaker 260 or input to the communication device 20 through the microphone 270. Instead, outbound communications originated by the user (i.e., speech spoken by the user) are received from the wireless earpiece via short range antenna 200 and passed to the transceiver 220 and/or processing circuitry 230, which decodes, descrambles, demaps, and/or demodulates the outbound communications to recapture outbound speech destined for another party in accordance with the particular wireless communication standard being implemented by the wireless earpiece. Thereafter, the transceiver 220 and/or processing circuitry 230 process the recovered outbound speech in accordance with a particular wireless communication standard used by the wireless network (e.g., IEEE 802.11a, IEEE 802.11b, Bluetooth, etc.) to produce an outbound radio frequency (RF) signal containing the formatted speech. The network antenna 210 transmits the outbound RF signal to the wireless network for forwarding to the destination party.

The transceiver 220 also receives inbound RF signals from the wireless network via the network antenna 210. The network antenna 210 provides the inbound RF signals to the transceiver 220 and/or processing circuitry 230, which decodes, descrambles, demaps, and/or demodulates the inbound signals to recapture inbound speech destined for the user in accordance with the particular wireless communication standard being implemented by the wireless network. The transceiver 220 and/or processing circuitry 230 process the recovered inbound speech in accordance with the particular wireless communication standard used by the wireless earpiece to produce an inbound RF signal containing the formatted speech. The short range antenna 200 transmits the inbound RF signal to the wireless earpiece for output to the user.

In handset mode, the speaker 260 and microphone 270 are enabled, and the short range antenna 200 is disabled. Inbound RF signals received from the wireless network via the network antenna 210 are provided to the transceiver 220 and/or processing circuitry 230 for decoding, descrambling, demapping, and/or demodulating to recapture inbound speech destined for the user in accordance with the particular wireless communication standard being implemented by the wireless network. The recovered speech is output as an audio signal to the user via speaker 260. Outbound RF signals are received via microphone 270 and processed by the processing circuitry 230 and/or transceiver 220 in accordance with a particular wireless communication standard used by the wireless network (e.g., IEEE 802.11a, IEEE 802.11b, Bluetooth, etc.) to produce an outbound radio frequency (RF) signal containing the formatted speech. The network antenna 210 transmits the outbound RF signal to the wireless network for forwarding to the destination party.

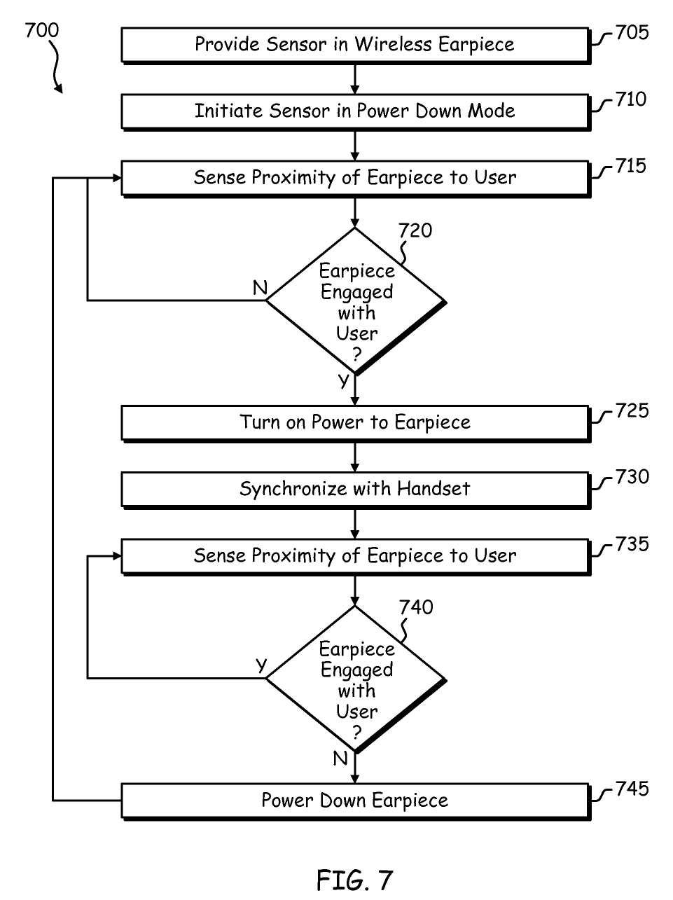

FIG. 7 is a logic diagram of a method 700 for operating a wireless earpiece in accordance with the present invention. The method begins at step 705, where a proximity sensor is provided within the wireless earpiece to detect the proximity of the wireless earpiece to a user and determine when the wireless earpiece is engaged with the user.

The process then proceeds to step 710, where the sensor is initiated while the wireless earpiece is in a power down (or power OFF) mode. At step 715 the sensor senses the proximity of the wireless earpiece to a user and produces a proximity signal indicative thereof. At step 720, a determination is made based on the proximity signal whether the wireless earpiece is engaged with the user. If not, the process continues at step 715, where the sensor continues to sense the proximity of the wireless earpiece to the user. If it is determined that the wireless earpiece is engaged with the user, the process then proceeds to step 725, where the power to the wireless earpiece is turned on (power ON mode). Thereafter, at step 730, the wireless earpiece synchronizes with a handset or other communication device using a short range wireless protocol to establish a connection with the handset or other communication device.

The process continues at step 735, where the sensor again senses the proximity of the wireless earpiece to the user. At step 740, a determination is again made based on the proximity signal whether the wireless earpiece is engaged with the user. If it is determined that the wireless earpiece is still engaged with the user, the process continues at step 735, where the sensor continues to sense the proximity of the wireless earpiece to the user. However, if it is determined that the wireless earpiece is no longer engaged with the user, the process then proceeds to step 745, where the power to the wireless earpiece is turned off (returns to power OFF mode). The process repeats at step 715, where the sensor again begins to sense the proximity of the wireless earpiece to the user while in power OFF mode.

As one of ordinary skill in the art will appreciate, the term “substantially,” as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”.

The preceding discussion has presented a wireless earpiece incorporating a sensor for determining the proximity to a user and method of operation thereof. As one of ordinary skill in the art will appreciate, other embodiments may be derived from the teaching of the present invention without deviating from the scope of the claims.

What is claimed is:

1. A wireless earpiece configured to fit to an ear of a user, comprising:
a transceiver operable to communicate with a communication device in a wireless earpiece mode;
a sensor operable to sense a proximity of said wireless earpiece to the user and to produce a proximity signal in response thereto; and
processing circuitry coupled to receive said proximity signal from said sensor and operable to initiate said wireless earpiece mode when said proximity signal indicates said wireless earpiece is engaged with the user.

2. The wireless earpiece of claim 1, wherein said processing circuitry is further operable to initiate a handset mode of said wireless earpiece when said proximity signal indicates said wireless earpiece is not engaged with the user, said handset mode causing said transceiver to discontinue communication with said radio device.

3. The wireless earpiece of claim 1, further comprising:
a power device operable to provide power to said wireless earpiece; and
a power controller operable to turn on said power device in said wireless earpiece mode and turn off said power device in said handset mode.

4. The wireless earpiece of claim 3, wherein said transceiver is operable to synchronize with said communication device upon initiation of said wireless earpiece mode to enable said communication device to forward incoming communications received for the user to said wireless earpiece without providing said incoming communications to an output of said communication device and to receive outgoing communications from the user via said wireless earpiece instead of through an input of said communication device.

5. The wireless earpiece of claim 1, wherein said sensor is a capacitive sensor.

6. The wireless earpiece of claim 1, wherein said sensor is a temperature sensor.

7. The wireless earpiece of claim 1, wherein said sensor includes a speaker and microphone of said wireless earpiece configured to measure a feedback path gain therebetween.

8. The wireless earpiece of claim 1, wherein said sensor includes a speaker of said wireless earpiece having a passive receiver coupled thereto to measure an echo from an eardrum of the user.

9. The wireless earpiece of claim 1, wherein said sensor is configured to sense proximity of the user by sensing a change in a gain of an antenna of said wireless earpiece.

10. A communication system, comprising:
a wireless earpiece configured to fit to an ear of a user and operable to sense a proximity thereof to the user to determine when said wireless earpiece is engaged with the user, said wireless earpiece further operable to automatically initiate a wireless earpiece mode when engaged with the user and to automatically initiate a handset mode when not engaged with the user; and
a communication device operable to communicate with said wireless earpiece in said wireless earpiece mode and to discontinue communication with said wireless earpiece in said handset mode.

11. The communication system of claim 10, wherein said wireless earpiece further includes:
a power device operable to provide power to said wireless earpiece; and
a power controller operable to turn on said power device in said wireless earpiece mode and turn off said power device in said handset mode.

12. The communication system of claim 10, wherein said wireless earpiece is further operable to synchronize with said communication device upon initiation of said wireless earpiece mode to enable said communication device to forward incoming communications received for the user to said wireless earpiece without providing said incoming communications to an output of said communication device and to receive outgoing communications from the user via said wireless earpiece instead of through an input of said communication device.

13. The communication system of claim 12, wherein, upon initiation of said handset mode, said communication device discontinues communicating with said wireless earpiece such that said incoming communications are provided to said output of said communication device and said outgoing communications are received from the user via said input of said communication device.

14. The communication system of claim 10, wherein said wireless earpiece includes a sensor for sensing the proximity of said wireless earpiece to the user.

15. A method for providing communication between a wireless earpiece configured to fit to an ear of a user and a communication device, said method comprising:
sensing a proximity of said wireless earpiece to the user and producing a proximity signal in response thereto;
initiating a wireless earpiece mode of said wireless earpiece when said proximity signal indicates said wireless earpiece is engaged with the user; and
automatically facilitating communication between said wireless earpiece and said communication device in said wireless earpiece mode.

16. The method of claim 15, wherein said automatically facilitating communication between said wireless earpiece and said communication device further comprises:
turning on power to said wireless earpiece in said wireless earpiece mode.

17. The method of claim 16, wherein said automatically facilitating communication between said wireless earpiece and said communication device further comprises:
synchronizing with said radio device upon initiation of said wireless earpiece mode to enable said communication device to forward incoming communications received for the user to said wireless earpiece without providing said incoming communications to an output of said communication device and to receive outgoing communications from the user via said wireless earpiece instead of through an input of said communication device.

18. The method of claim 17, further comprising:
initiating a handset mode of said wireless earpiece when said proximity signal indicates said wireless earpiece is not engaged with the user; and
automatically discontinuing communication between said wireless earpiece and said communication device in said handset mode.

19. The method of claim 18, wherein said automatically discontinuing communication between said wireless earpiece and said communication device in said handset mode further comprises:
turning off power to said wireless earpiece in said handset mode.

20. The method of claim 19, wherein said automatically discontinuing communication between said wireless earpiece and said communication device in said handset mode further comprises:
discontinuing communicating with said wireless earpiece;
providing said incoming communications to the user to said output of said communication device; and
receiving said outgoing communications from the user via said input of said communication device.
